(19) United States
(12) Patent Application Publication
(10) Pub. No.: US 2010/0104303 A1
(43) Pub. Date: Apr. 29, 2010

(54) IMAGE FORMING APPARATUS

(75) Inventors: Jong-moon EUN, Seoul (KR); In-cheol Jeon, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/545,208

(22) Filed: Aug. 21, 2009

(30) Foreign Application Priority Data
Oct. 28, 2008 (KR) 2008-0105936

(51) Int. Cl. G03G 15/043; G03G 15/01

(52) U.S. Cl. 399/51; 399/223

(57) ABSTRACT

An image forming apparatus includes a developing device including at least one image unit using developers of opposite polarities and different colors simultaneously, and at least one image unit using a single color developer of a constant polarity, a light source device including a plurality of light sources to form an electrostatic latent image on the plurality of image units, and a controller to control output of the light source in at least three output levels.

### CROSS-REFERENCE TO RELATED APPLICATIONS

This application claims priority under 35 U.S.C. §119 (a) from Korean Patent Application No. 10-2008-0105936, filed on Oct. 28, 2008, in the Korean Intellectual Property Office, the disclosure of which is incorporated herein in its entirety by reference.

### BACKGROUND

1. Field of the Invention

The present general inventive concept relates to an image forming apparatus, and more particularly, to an image forming apparatus which has an image unit capable of using at least one developer on a single image receptor.

2. Description of the Related Art

Recently, various methods have been suggested to solve problems of electrophotographic image forming apparatuses. One of them is to reduce a diameter of light emitted from a light source device, to thereby improve a resolution. However, if the diameter of light is reduced, it is difficult to guarantee reproduction of an electrostatic latent image formed by emitting light, and thus uneven distribution of the latent image occurs and the resolution is reduced. Particularly, a desirable gradation cannot be obtained in a low density section and sharpness of an image is reduced.

An alternative method is to add a light color developer in addition to 4-color developers, to thereby improve color reproduction of color images. For example, if image units are modified to include a light cyan developer and a light magenta developer as a light color developer, in addition to 4-color developers such as cyan, magenta, yellow, and black developers, deterioration in image quality on a light color area can be reduced and color reproduction and gradation can be improved.

However, if an image unit using a light color developer is modified to use a light color developer such as a light cyan developer and a light magenta developer, the number of image units increases, which, in turn, increases a volume of the image forming apparatus. Also, since an additional light source device is required to correspond to the added image unit, manufacturing costs of a product including the image unit increases.

### SUMMARY

Exemplary embodiments of the present general inventive concept provide an image forming apparatus which is capable of minimizing the number of developing components and improving an image quality.

Additional features and/or utilities of the present general inventive concept will be set forth in part in the description which follows and, in part, will be obvious from the description, or may be learned by practice of the general inventive concept.

Exemplary embodiments of the present general inventive concept may be achieved by providing an image forming apparatus which includes a developing device including at least one image unit using developers of opposite polarities and different colors simultaneously, and at least one image unit using a single color developer of a constant polarity; a light source device including a plurality of light sources to form an electrostatic latent image on the plurality of image units; and a controller to control output of the light source in at least three output levels. The three output levels may include full-on, half-on, and off levels.

A negative polarity developer may be developed on a surface of an image receptor where an electrostatic latent image is formed by controlling the light source in the first output level of full-on, and a positive polarity developer may be developed on a surface of an image receptor where an electrostatic latent image is formed by controlling the light source in the second output level of off, and a surface of an image receptor where an electrostatic latent image is formed by controlling the light source in the third output level of half-on may be set to a non-image area on which a developer is not developed.

The positive polarity developer may have an electric charge from about +5 to about +50 μC/g, and the negative polarity developer may have an electric charge from about −5 to about −50 μC/g.

The developing device may include first through third image units which use single-color developers of a same polarity, and a fourth image unit which uses developers of different polarities.

The first image unit may use a yellow developer, the second image unit may use a magenta developer, and the third image unit may use a dark cyan developer, and the fourth image unit may include a first developing unit using a light cyan developer having the same polarity as the developers used in the first through the third image units, and a second developing unit using a black developer having a polarity opposite to that of the developers of the first through the third image units.

The developing device may include a first image unit using a single color developer, and second and third image units which have a plurality of developing units using developers of different colors and different polarities.

The first image unit may use a yellow developer, the second image unit may include a first developing unit using a magenta developer and a second developing unit using a dark cyan developer, and the third image unit may include a third developing unit using a light cyan developer and a fourth developing unit using a black developer.

The developers used in the first and the third developing units may have a polarity opposite to that of the developers used in the second and the fourth developing units.

The developing device may include first through third image units each having a plurality of developing units using developers of different colors and different polarities.

The first image unit may include a first developing unit using a yellow developer and a second developing unit using a dark cyan developer, the second image unit may include a third developing unit using a magenta developer and a fourth developing unit using a dark cyan developer, and the third image unit may include a fifth developing unit using a light cyan developer and a sixth developing unit using a black developer.

The developers used in the first, third, and fifth developing units may have a polarity opposite to that of the developers used in the second, fourth, and sixth developing units.

The developing device may include first and fourth image unit using developers of different polarities, and second and third image units using single-color developers of the same polarity.

The first image unit may include a first developing unit using a yellow developer and a second developing unit using a light magenta developer, the second unit may use a dark magenta developer, the third image unit may use a dark cyan developer, and the fourth image unit may include a third developing unit using a light cyan developer and a fourth developing unit using a black developer.

The developing device may include first, third and fourth image units each using developers of different polarities, and a second image unit using a single color developer of a single polarity.

The first image unit may include a first developing unit using a yellow developer and a second developing unit using a light magenta developer, the second image unit may use a dark magenta developer, the third image unit may include a third developing unit using a dark cyan developer and a fourth developing unit using a gray developer, and the fourth image unit may include a fifth developing unit using a light cyan and a sixth developing unit using a black developer.

The developing device may include first through fourth image units each using developers of opposite polarities.

The first image unit may include a first developing unit using a yellow developer and a second developing unit using a light magenta developer, the second image unit may include a third developing unit using a dark magenta developer and a fourth developing unit using a gold developer, the third image unit may include a fifth developing unit using a dark cyan developer and a sixth developing unit using a silver developer, and the fourth image unit may include a seventh developer using a light cyan developer and an eighth developing unit using a black developer.

The developing device may further include a developer charging device to make the polarity of the developer developed on the image receptor uniform.

The developer charging device may include a corona charging device.

Exemplary embodiments of the present general inventive concept may also be achieved by providing an image forming apparatus which includes a developing device which includes at least one image unit using developers of opposite polarities and different colors, a light source device which includes a plurality of light sources to form an electrostatic latent image in the at least one image unit, and a controller to control output of the light sources in a three output level way. The three output levels may include a first output level of full-on, a second output level of half-on, and a third output level of off, and a negative polarity developer may be developed on a surface of an image receptor where an electrostatic latent image is formed by controlling the light source in the first output level of full-on, a positive polarity developer may be developed on a surface of an image receptor where an electrostatic latent image is formed by controlling the light source in the second output level of off, and a surface of an image receptor where an electrostatic latent image is formed by controlling the light source in the third output level of half-on may be set to a non-image area on which a developer is not developed.

Exemplary embodiments of the present general inventive concept may also be achieved by providing a method of creating an image of an image forming apparatus which includes developing developers of at least one image unit having opposite polarities and different colors simultaneously, the at least one image unit using a single color developer of a constant polarity, forming an electrostatic latent image on the at least one image unit by controlling a light source device having a plurality of light sources, and controlling an output of the light source device in at least three output levels.

Exemplary embodiments of the present general inventive concept may also be achieved by providing an image unit usable in an image forming apparatus which includes an image receptacle to be charged with three different levels to be formed with an electrostatic latent image and two developing units disposed around the image receptacle to develop the electrostatic latent image with three different levels with two different developers.

The image unit may further include a light source to output light with three different levels to the image receptacle to form the electrostatic latent image.

The image unit may further include a developer collecting unit to collect two developers from the image receptacle.

Exemplary embodiments of the present general inventive concept may also be achieved by providing an image forming apparatus having an image unit which includes an image receptacle to be charged with three different levels to be formed with an electrostatic latent image and two developing units disposed around the image receptacle to develop the latent image with three different levels with two different developers, a light source including a plurality of light sources to form the electrostatic latent image on the image unit and a controller to control output of the light source in at least three output levels.

The plurality of light sources may include a third output level in which the first and second developers are not developed to define a non-image area.

The first developer may have a negative polarity and the second developer may have a positive polarity.

The first developer may have a first electrical charge from about +5 to about +50 μC/g.

The second developer may have a second electrical charge from about −5 to about −50 μC/g.

The at least one image unit may include a first image unit having the first and second developers and a second image unit having a third developer.

A polarity of the third developer may correspond to the polarity of one of the first and second developers.

### BRIEF DESCRIPTION OF THE DRAWINGS

These and/or other features and/or utilities of the present general inventive concept will become apparent and more readily appreciated from the following description of the exemplary embodiments, taken in conjunction with the accompanying drawings of which:

FIGS. 1 through 6 are cross-sectional schematic views illustrating an image forming apparatus according to exemplary embodiments of the present general inventive concept;

FIG. 7 is a schematic view illustrating a control device to control a light source according to an exemplary embodiment of the present general inventive concept;

FIG. 8 illustrates a process of developing developers of different colors on a surface of an image receptor by controlling a light source according to an exemplary embodiment of the present general inventive concept;

FIG. 9 is a schematic view illustrating developing units using developers of different colors and different polarities on a single image receptor;

FIG. 10 illustrates change in a surface electric potential of the image receptor when the light source is controlled in a 3 output level way; and

FIG. 11 is a flowchart illustrating an exemplary embodiment of a method of creating an image of an image forming apparatus according to the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

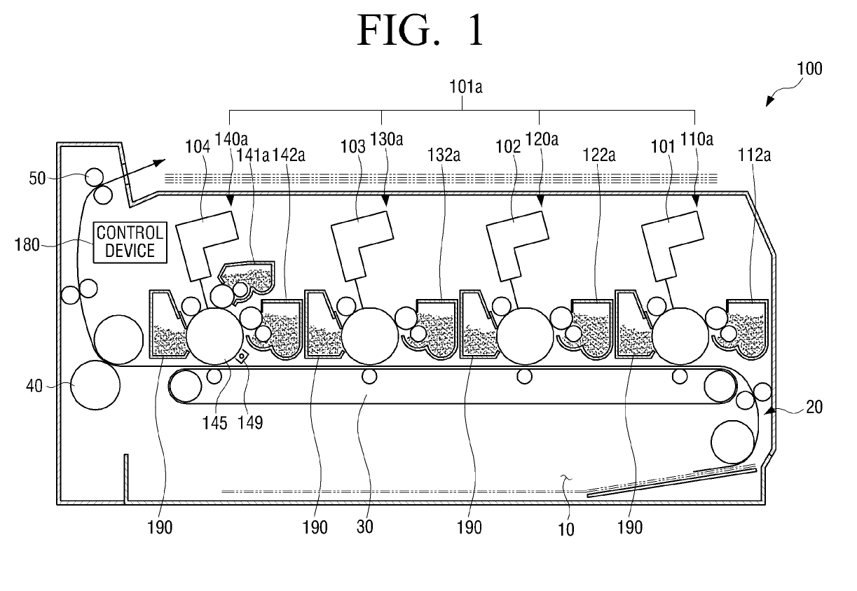

Referring to FIG. 1, an image forming apparatus 100 according to an exemplary embodiment of the present general inventive concept may include a paper feeding unit 10, a conveying unit 20, a developing device 101a, a transfer unit 30, a fusing unit 40, and a paper discharging unit 50.

The paper feeding unit 10 stacks a plurality of sheets of printing paper thereon and the conveying unit 20 picks up and conveys the printing paper from the paper feeding unit 10. The developing device 101a and the transfer unit 30, having an intermediate transfer belt, form a printing image on paper conveyed by the conveying unit 20, and the fusing unit 40 fixes the printing image onto a surface of the paper by using heat and/or pressure. Then, the paper is discharged to an external environment by the paper discharging unit 50.

The developing device 101a may include first through fourth image units 110a, 120a, 130a, 140a, and according to an exemplary embodiment of the present general inventive concept, as illustrated in FIG. 1, at least one of the image units (110a, 120a, 130a, 140a) may include a plurality of developing units, such that a total of 5-color developers are used.

The first through the fourth image units 110a, 120a, 130a, 140a are provided with image receptors, respectively, which are individually exposed to light by first through fourth light sources 101, 102, 103, 104. In exemplary embodiments, the first through the fourth light sources 101, 102, 103, 104 may be laser scanning devices or light sources using light emitting diode (LED). However, the present general inventive concept is not limited thereto. The first through the fourth light sources 101, 102, 103, 104 are controlled in a 3 output level way, that is, in a first output level of “full-on”, a second output level of “half-on”, and a third output level of “off”, by a predetermined control device such that developers of different polarities are developed on a single image receptor. In the present exemplary embodiment, the fourth light source 104 corresponding to the fourth image unit 140a, which uses developers of different polarities simultaneously, is controlled in such a 3 output level way and a method thereof will be described in detail later.

In the developing device according to an exemplary embodiment of the present general inventive concept, as illustrated in FIG. 1, the first through the third image units 110a, 120a, 130a use single-color developers of a same polarity and the fourth image unit 140a uses developers of different polarities.

In an exemplary embodiment, the first image unit 110a, the second image unit 120, and the third image unit 130a use yellow, magenta, and dark cyan developers, respectively, and the fourth image unit 140a may include a first developing unit 141a using a black developer having a same polarity as the developers used in the first through the third image units 110a, 120a, 130a and a second developing unit 142a using a light cyan developer having a polarity opposite to that of the developers used in the first through the third image units 110a, 120a, 130a.

In exemplary embodiments, the yellow, magenta, and dark cyan developers used in the first through the third image units 110a, 120a, 130a and the black developer used in the fourth developing unit 141a may have a negative polarity, whereas the light cyan developer used in the second developing unit 142a may have a positive polarity. However, the present general inventive concept is not limited thereto. That is, in exemplary embodiments, the developers in the first through third image units 110a, 120a, and 130a and the fourth developing unit 141a may have a positive polarity and the developer in the second developing unit 142a may have a negative polarity.

A developer charging device 149 may be provided in the fourth image unit 140a having the plurality of developing units to charge the developers developed on the image receptor. In exemplary embodiments, the developer charging device 149 may also serve to change the polarities of the light cyan developer and the black developer developed on the image receptor to the same polarity as the developers of the first through the third image units 110a, 120a, 130a. In further exemplary embodiments, the developer charging device 149 may be a corona charging device to charge the developer developed on the image receptor in a non-contact way. However, the present general inventive concept is not limited thereto.

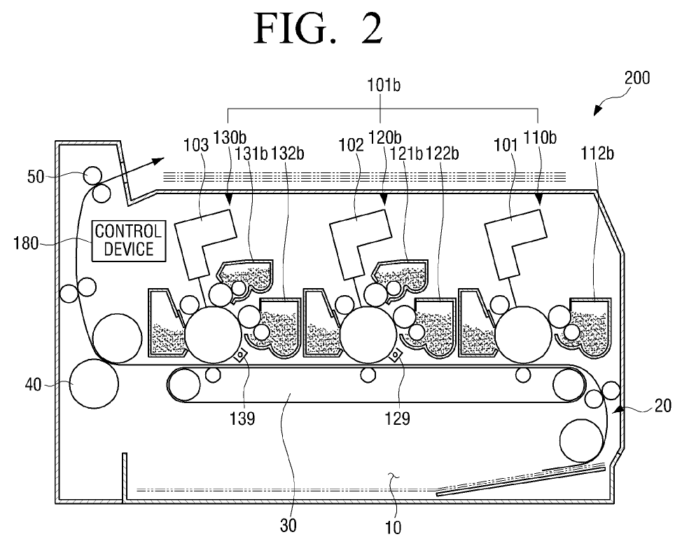

According to another exemplary embodiment of the present general inventive concept, as illustrated in FIG. 2, the developing device 101b may include a first image unit 110b which uses a single color developer, and a second image unit 120b and a third image unit 130b which have a plurality of developing units using developers of different colors and different polarities. In the present exemplary embodiment, the number of image units is reduced as compared to a conventional developing device using 4-color developers, thereby making it possible to apply the developing device to a smaller color image forming apparatus. Also, although the number of image units is reduced, the number of developers used is increased to five so that color reproduction may be further improved. First through third light sources 101, 102, 103 are provided to form electrostatic latent images in the first through the third image units 110b, 120b, 130b. The second and the third light sources 102,103 are controlled in a 3 output level way similar to the fourth light source 104 of the previous exemplary embodiment, such that developers of different colors and different polarities are simultaneously developed on a single image receptor.

In an exemplary embodiment, the first image unit 110 uses a yellow developer. The second image unit 120b may include a first developing unit 121b using a magenta developer and a second developing unit 122b using a dark cyan developer. The third image unit 130b may include a third developing unit 131b using a light cyan developer and a fourth developing unit 132b using a black developer.

In exemplary embodiments, the developers used in the first and the third developing units 121b, 131b may have polarities opposite to that of the developers used in the second and the fourth developing units 122b, 132b. Developer charging devices 129, 139 may be provided to change the different polarities of the developers to the same polarity as the yellow developer of the first image unit 110b, and may be a corona charging device. However, the present general inventive concept is not limited thereto.

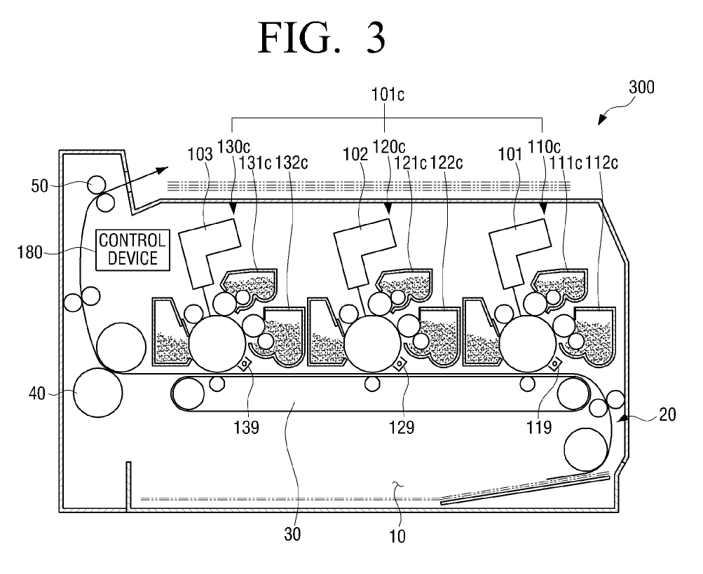

According to another exemplary embodiment of the present general inventive concept, as illustrated in FIG. 3, the developing device 101c may include first through third image units 110c, 120c, 130c each having a plurality of developing units using developers of different colors and different polarities.

In an exemplary embodiment, the first image unit 110c may include a first developing unit 111c using a yellow developer and a second developing unit 112c using a dark cyan developer. The second image unit 120c may include a third developing unit 121c using a magenta developer and a fourth developing unit 122c using a dark cyan developer. The third image unit 130c may include a fifth developing unit 131c using a light cyan developer and a sixth developing unit 132c using a black developer. Since such arrangements of developers make it possible to overlap the yellow developer and the dark cyan developer, image quality may be improved and also a compactness of a final product may be achieved.

In the same configuration, in exemplary embodiments, the third developing unit 121c may use a dark magenta developer and the fourth developing unit 122c may use a light magenta developer. In this case, if there is a necessity to overlap yellow and dark cyan, the first image unit 110 develops the yellow developer first, and if there is a necessity to overlap dark magenta and light magenta, the dark magenta developer is developed first. Also, in order to overlap light cyan and black developers in a same position, the black developer may be developed first.

In exemplary embodiments, the developers used in the first, third, and fifth developing units 111c, 121c, 131c may have polarities opposite to that of the developers used in the second, fourth, and sixth developing units 112c, 122c, 132c.

In exemplary embodiments, developer charging devices 119, 129, 139 may be provided to change the different polarities of developers to a same polarity.

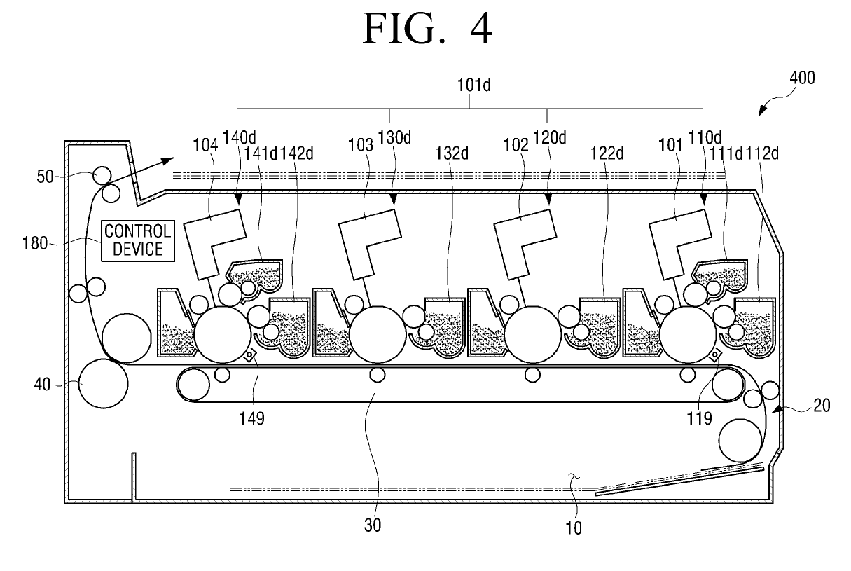

According to another exemplary embodiment of the present general inventive concept, as illustrated in FIG. 4, the developing device 101d may include a first image unit 110d and a fourth image unit 140d using developers of different polarities, and a second image unit 120d and a third image unit 130d using single-color developers of the same polarity.

In exemplary embodiments, the first image unit 110d may include a first developing unit 111d using a yellow developer and a second developing unit 112d using a light magenta developer, the second image unit 120d may use a dark magenta developer, the third image unit 130d may use a dark cyan developer, and the fourth image unit 140d may include a third developing device 141d using a light cyan developer and a fourth developing device 142d using a black developer. However, the present general inventive concept is not limited thereto.

Developer charging devices 119, 149 changes the different polarities of the developers used in the first and the fourth image units 110d, 140d to the same polarity as the developers used in the second and the third image unit 120d, 130d.

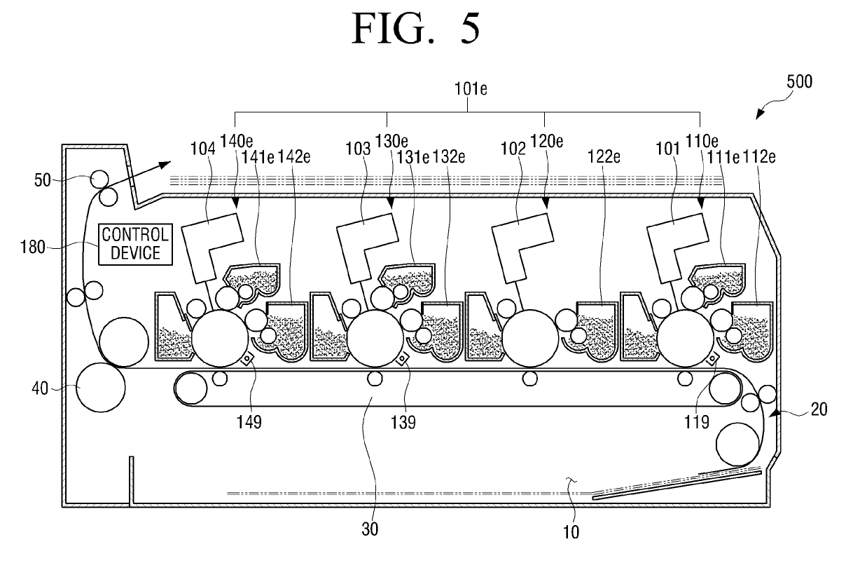

According to another exemplary embodiment of the present general inventive concept, as illustrated in FIG. 5, the developing device 110e may include a first image unit 110e, a third image unit 130e, and a fourth image unit 140e using developers of different polarities, and a second image unit 120e using a single-color developer of a single polarity.

In an exemplary embodiment, the first image unit 110e may include a first developing unit 111e using a yellow developer and a second developing unit 112e using a light magenta developer, the second image unit 120e may use a dark magenta developer, the third image unit 130e may include a third developing unit 131e using a dark cyan developer and a fourth developing unit 132e using a gray developer, and the fourth image unit 140e may include a fifth developing unit 141e using a light cyan developer and a sixth developing unit 142e using a black developer. However, the present general inventive concept is not limited thereto.

Developer charging devices 119, 139, 149 may be provided to change the different polarities of the developers developed on the image receptor to the same polarity as the developer used in the second image unit 120e.

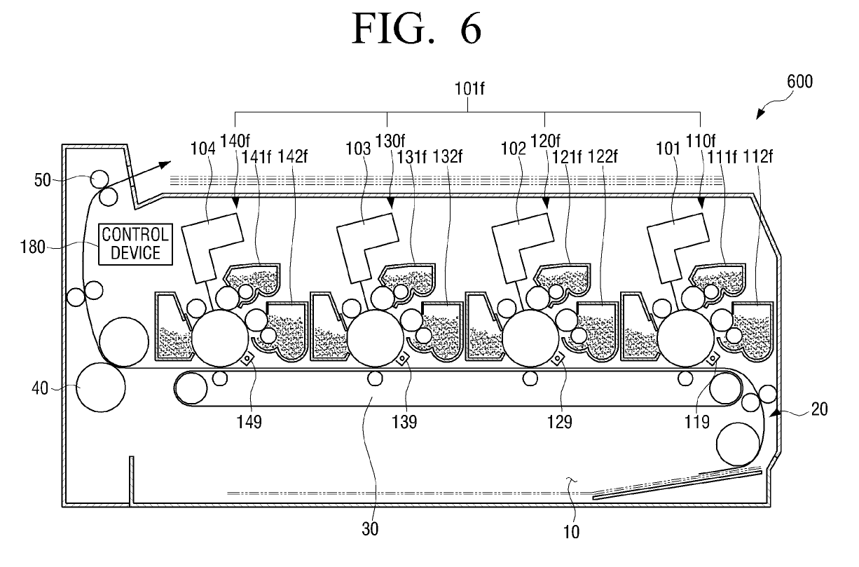

According to yet another exemplary embodiment of the present general inventive concept, as illustrated in FIG. 6, the developing device 101f may include first through fourth image units 110f, 120f, 130f, 140f each using developers of different polarities.

In an exemplary embodiment, the first image unit 110f may include a first developing unit 111f using a yellow developer and a second developing unit 112f using a light magenta developer, the second image unit 120f may include a third developing unit 121f using a dark magenta developer and a fourth developing unit 122f using a gold developer, the third image unit 130f may include a fifth developing unit 131f using a dark cyan developer and a sixth developing unit 132f using a silver developer, and the fourth image unit 140f may include a seventh developing unit 141f using a light cyan developer and an eighth developing unit 142f using a black developer. However, the present general inventive concept is not limited thereto.

In exemplary embodiments, developer charging devices 119, 129, 139, 149 may be provided to change the different polarities of developers developed on the image receptor to the same polarity.

In exemplary embodiments, color reproduction of a color image may be improved without requiring an additional light source and image receptor. Accordingly, based on the configuration illustrated in the above exemplary embodiments, it is possible to combine various colors and enlarge a color representation area by simply adding a predetermined color.

In exemplary embodiments, the image forming apparatus 100 may include a control device 180 to control operations of the image forming apparatus, and a developer (toner) collector 190 to receive or collect two different developers (toners) from the image receptor 145. That is, in an exemplary embodiment, the image forming apparatus 100 may include the developer collector 190 to collect a developer from the first developing unit 141a and another different developer from the second developing unit 142a, which are both used to form a latent image on the image receptor 145. However, the present general inventive concept is not limited thereto. That is, in alternative exemplary embodiments, the image forming apparatus 100 may include three or more different developers which may be used to form a latent image on a single image receptor.

As described above, an image unit may include an image receptor 145, two separate developing units 141a, 142a disposed around the image receptor 145, a fourth light source 104, a control device 180, a toner collector 190 to collect toner from the two separate developing units 141a, 142, and a charging device 149 to charge the different developers of the developing units 141a, 142.

In exemplary embodiments, the control device 180 may be used to control operations of the image forming apparatus 100. In particular, the control device 180 may be used to control the plurality of light sources 101, 102, 103, 104 to output light in three different output levels. In an exemplary embodiment, a first output level may correspond to the development of a first developer, a second output level may correspond to the development of a second developer, and a third output level may correspond to the development of no developers. However, the present general inventive concept is not limited thereto. That is, in alternative exemplary embodiments, each light source may be controlled by the control device 180 to be output in four or more output levels, corresponding to the development of at least three different developers (toners).

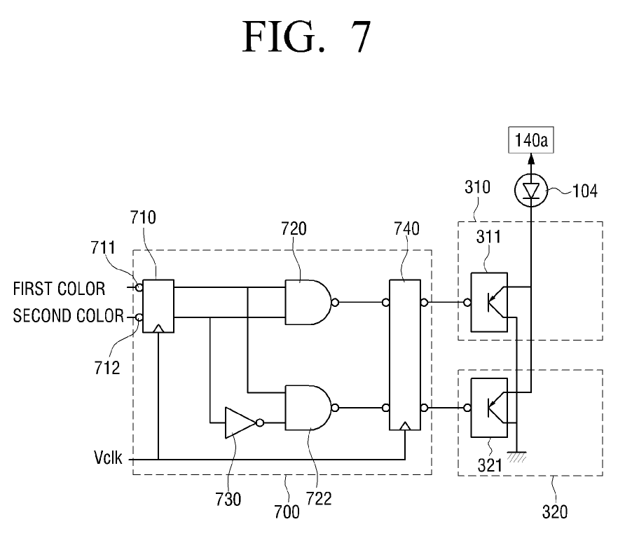

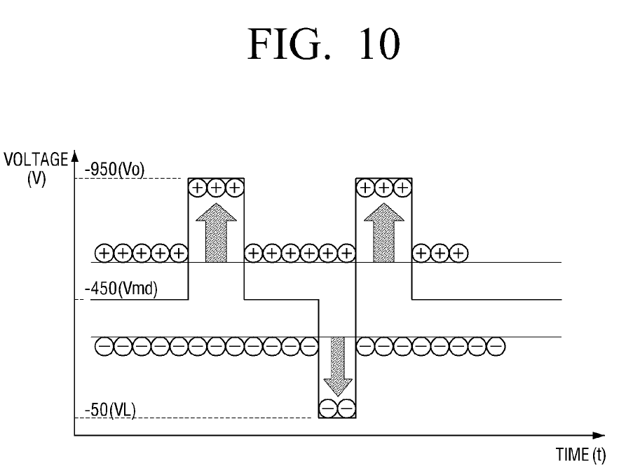

A method of controlling the first through the fourth light sources 101, 102, 103, 104 in a 3 output level way according to an exemplary embodiment of the present general inventive concept will now be described with reference to FIGS. 7 and 10.

FIG. 7 is a schematic view illustrating a control device to control a light source if two developing units using color developers of different polarities are installed in a single image unit. In exemplary embodiments, the control device may be the control device 180 of FIG. 1 and may include a controller 700 to input logic values and first and second drivers 310, 320. In exemplary embodiments, the control device 180 may include a flip flop unit 710, first and second NAND gates 720, 722, and an inverter 730 connected between the flip flop unit 710 and the second NAND gate 722. The flip flop unit 710 may be controlled based on the color of developers used within the single image unit. In exemplary embodiments, the flip flop unit 710 receives input signals at first and second input terminals 711, 712 representing first and second colors, respectively, and a clock signal Vclk, and transmits output signals to input terminals of the first and second NAND gates 720, 722 and an input terminal of the inverter 730. The first and second NAND gates may transmit output signals to an output unit 740. The output unit 740 may then transmit output signals to the middle driver 311 and the full driver 321 to control an output level of the light source 104, which is transmitted to the fourth image unit 140a.

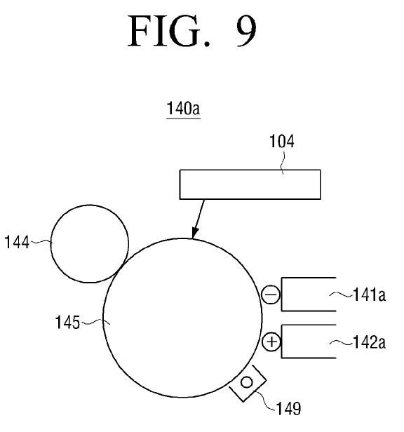

In an exemplary embodiment, if a plurality of developing units using developers of different colors and different polarities are installed on a single image receptor, the control device may be provided to control a light source to form an electrostatic latent image on the image receptor. For a better understanding, the fourth light source 104 of the exemplary embodiment illustrated in FIG. 1, will now be described by way of an example within FIG. 9.

Referring to FIG. 9, the fourth image unit 140a may include a charging unit 144, an image receptor 145, and a developer charging device 149. In exemplary embodiments, the image receptor 145 may be charged with about −950V by the charging unit 144.

As illustrated in FIG. 7, logic values 0, 0, 1, 1 may be input to the controller 700 to represent a first color A and logic values 0, 1, 0, 1 may be input to the controller 700 to represent a second color B. However, the present general inventive concept is not limited thereto. A middle driver 311 or a full driver 321 may be selectively switched by these input values to determine an output voltage of the fourth light source 104.

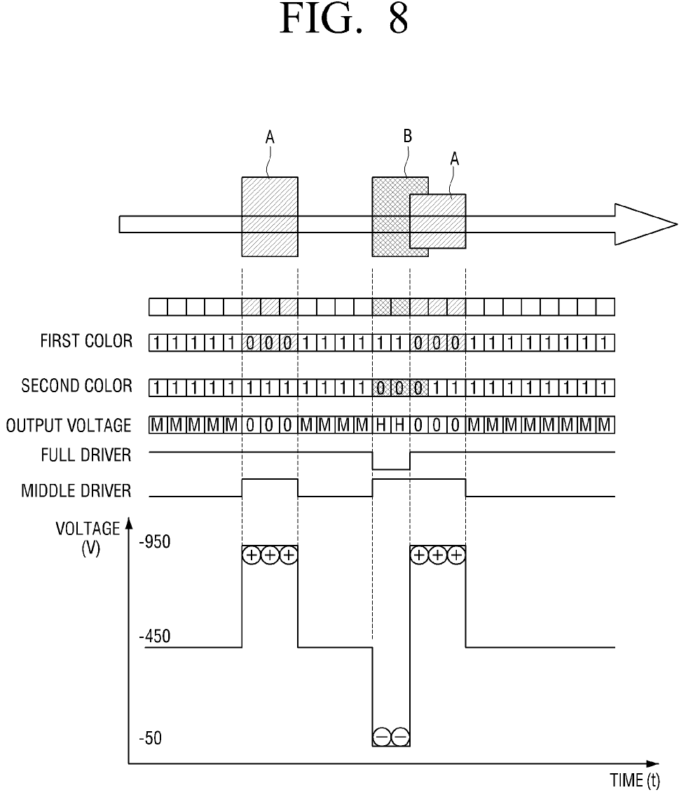

Accordingly, as illustrated in FIG. 8, in order to develop the first color A, the fourth light source 104 is controlled in the output level of “off” by the input logic values such that the image receptor 145 of the fourth image unit 140a is maintained at about −950V, which is an initially charged surface electric potential (V0) and the negative polarity developer of the first color A is developed on a corresponding position of the image receptor.

In exemplary embodiments, in order to form a non-image area, the fourth light source 104 is controlled in the output level of “half-on” to emit a middle level of light to the image receptor 145 to thereby make the surface electric potential equal to about −450V. In exemplary embodiments, if the surface electric potential becomes −450V, neither the positive polarity developer nor the negative polarity developer is developed on the surface of the image receptor, such that a non-image area is formed.

In order to develop a second color B, the fourth light source 104 is controlled in the output level of “full on” to emit a maximum level of light to the image receptor 145. Then, the surface electric potential of the image receptor 145 becomes about −50V such that a negative polarity developer is moved to an electrostatic latent image formed when controlled in the output level of “full-on.”

As illustrated in FIG. 8, in order to overlap the first color A and the second color B, the control device is set to develop the first color A first. However, the present general inventive concept is not limited thereto. That is, in exemplary embodiments, a priority may be changed to develop the second color B prior to developing the first color A, if necessary. In exemplary embodiments, the image forming apparatus 100 may include a middle driver 311 and a full driver 321 to control output levels of the image units to thereby control the development of the first and second colors A and B. That is, when the flip flop circuit 710 receives an input of “0” at the first terminal 711, the first color A may be developed. Similarly, when the flip flop circuit 710 receives an input of “0” at the second terminal 712, the second color B is developed. In particular, the middle driver 311 may control the developer charging device 139 to charge the image receptor 145 to “−950V” so that the first color A may be developed. The full driver 321 may control the developer charging device 139 to charge the receptor 145 to “−50V” so that the second color B may be developed. The output voltage signal corresponding to the development of the first color A may be “0” and the output voltage signal corresponding to the development of the second color B may be “H.” In exemplary embodiments, when the flip flop circuit 710 receives an input of “1” at either the first or second terminals, neither of the first and second colors A and B may be developed.

FIG. 10 illustrates a change in the surface electric potential of the image receptor 145 to develop the first color A developer and the second color B developer through an exemplary embodiment of a process according to the present general inventive concept.

As illustrated in FIG. 10, in order to form a non-image area, the fourth light source 104 is controlled in the output level of “half-on” to expose the image receptor 145, which has been initially charged with about −950V (V0) to light and thereby makes the surface electric potential of the image receptor 145 equal to about −450V.

In order to develop the first color A using the positive polarity developer, the fourth light source 104 is controlled in the output level of “off” to maintain the surface of the image receptor at about −950V, which is an initially charged surface electric potential. In an exemplary embodiment, a voltage of about −650V (Bias 1) may be applied to the developing unit to develop a positive polarity developer. However, the present general inventive concept is not limited thereto.

In order to develop the second color B using the negative polarity developer, the fourth light source 104 is controlled in the output level of “full-on” to expose the surface of the image receptor to light and thereby make the surface electric potential of the image receptor 145 equal to about −50V. In an exemplary embodiment, a voltage of about −350V (Bias 2) may be applied to the developing unit in order to develop a negative polarity developer.

In exemplary embodiments, the developer having a positive polarity may have an electric charge from about +5 to about +50 μC/g.

In exemplary embodiments, the condition for developing the first color A using a positive polarity developer satisfies equation 1 and an electric field condition in a non-image area satisfies equation 2:

|V0|−Bias 1|>50 [Equation 1]

|Bias 1|−|Vmd|>50 [Equation 2]

wherein “V0” denotes a surface electric potential of the image receptor 145 set by the charging device 144 if the fourth light source 104 is controlled in the output level of “off”, “Vmd” denotes a surface electric potential of the image receptor 145 if the fourth light source 104 is controlled in the output level of “half-on”, and “Bias 1” denotes a developing bias voltage of the first color A developer. However, the present general inventive concept is not limited thereto.

In exemplary embodiments, the developer having a negative polarity may have an electric charge from about −5 to about −50 μC/g.

In exemplary embodiments, the condition for developing the second color B using a negative polarity developer satisfies equation 3 and an electric field condition in a non-image area satisfies equation 4:

|Bias 2|−VL|>b 50 [Equation 3]

|Vmd|−|Bias 2>|50 [Equation 4]

wherein “VL” denotes a surface electric potential of the image receptor 145 if the fourth light source 104 is controlled in the output level of “full-on”, “Vmd” denotes a surface electric potential of the image receptor 145 if the fourth light source 104 is controlled in the output level of “half-on”, and “Bias 2” denotes a developing bias voltage of the second color B developer.

Hereinafter, a color image forming method of an image forming apparatus according to an exemplary embodiment of the present general inventive concept will be described with reference to accompanying drawings.

FIG. 1 illustrates an image forming apparatus using 5-color developers according to an exemplary embodiment of the present general inventive concept.

In exemplary embodiments, the 5-color developers form a dark color or a light color by adjusting one of a brightness, a saturation, and a hue regarding one of yellow, magenta, cyan, and black. In an exemplary embodiment, the first developing unit 141a using a light cyan as a light developer is added to the fourth image unit 140a and a dark cyan is used as a dark developer. The second developing unit 142a of the fourth image unit 140a uses a black developer. According to the configuration of the present exemplary embodiment, yellow, magenta, and dark cyan form a color image in a similar method as that of a conventional developing device by adopting a tandem method.

In exemplary embodiments, the fourth image unit 140a, which simultaneously develops the light cyan and the black developers by using a common single light source, represents two colors on the surface of the image receptor 145 by controlling the fourth light source 104 in a three output level way, as described above.

In the present exemplary embodiment, in order to overlap the light cyan and the black simultaneously in a same position, a positive polarity developer is first developed. That is, if the black developer is set to have a positive polarity and the light cyan is set to have a negative polarity, the black developer is developed first. However, the present general inventive concept is not limited thereto.

Generally, in order to represent a color image in which a black color is less represented, a light cyan or a dark cyan is selectively used to represent a color. Since the light cyan or the dark cyan is selectively used or both are used in parallel depending on image density such as highlight area, halftone area, or solid area, an image quality may be significantly improved.

In an exemplary embodiment, in order to reproduce five colors, the light cyan may be provided along with the black. However, the present general inventive concept is not limited thereto. That is, in exemplary embodiments, the light cyan may be provided along with the dark cyan.

In the above configuration, the 2-color overlap makes it possible to express nine color combinations in total, as illustrated in table 1. In an exemplary embodiment, a color reproduction may be improved as compared to the six color combinations based on 4-color developers of a conventional developing device:

TABLE 1

| 1 | 2 | 3 | 4 | 5 | 6 | 7 | 8 | 9 |
|---|---|---|---|---|---|---|---|---|
| M | DC | LC | K | DC | LC | K | LC | K |
| Y | Y | Y | Y | M | M | M | DC | DC |

(Y: yellow, M: magenta, DC: dark cyan, LC: light cyan, K: black)

Also, in the above configuration, a 3-color overlap makes it possible to express eight color combinations in total, as illustrated in table 2. In an exemplary embodiment, a color reproduction may be improved as compared to the four color combinations based on the 4-color developers of the conventional developing device:

TABLE 2

| 1 | 2 | 3 | 4 | 5 | 6 | 7 | 8 |
|---|---|---|---|---|---|---|---|
| DC | LC | K | LC | K | K | K | LC |
| M | M | M | DC | DC | LC | DC | DC |
| Y | Y | Y | Y | Y | M | M | M |

(Y: yellow, M: magenta, DC: dark cyan, LC: light cyan, K: black)

In exemplary embodiments, when developers of different polarity and different colors are developed on a same image receptor as described above, the polarities of the developers need to be uniform so that the developers can be transferred along with the developers of the image unit, when using only a single color.

As illustrated in FIGS. 1 and 9, if developers of image unit 140a having different polarities are all developed on the image receptor 145, the developer charging device 149 may be used to change the polarity of the developers of the image unit 140a to the same polarity as the developers of the other image units 110a, 120a, 130a by using corona charging.

Since subsequent image forming operations are similar to the operations used in the conventional color image forming apparatus, which adopts a tandem method, a description thereof will be omitted.

FIG. 2 illustrates an image forming apparatus according to another exemplary embodiment of the present general inventive concept, in which a number of image units is reduced to three so as to minimize a volume of the image forming apparatus.

That is, since three light sources and three image units are used, it is impossible to simultaneously overlap a magenta developer and a dark cyan developer, which share a same image receptor. Also, it is impossible to simultaneously overlap a light cyan developer and a black developer. Accordingly, if there is a necessity to overlap the magenta developer and the dark cyan developer, the magenta is developed first, and if there is necessity to overlap the light cyan developer and the black developer, the black is developed first. However, the present general inventive concept is not limited thereto. That is, in exemplary embodiments, a priority may be changed to develop the light cyan developer prior to developing the black developer, if necessary

In the above configuration, the 2 color overlap makes it possible to express seven color combinations in total, as illustrated in table 3. It can be seen that color reproduction may be improved as compared to the six color combinations based on 4-color developers in the conventional developing device:

TABLE 3

| 1 | 2 | 3 | 4 | 5 | 6 | 7 |
|---|---|---|---|---|---|---|
| M | DC | LC | K | LC | K | LC |
| Y | Y | Y | Y | M | M | DC |

(Y: yellow, M: magenta, DC: dark cyan, LC: light cyan, K: black)

In the above configuration, the 3 color overlap makes it possible to express five color combinations in total, as illustrated in table 4. It can be seen that color reproduction may be improved as compared to the four color combinations based on 4-color developers in the conventional developing device:

TABLE 4

| 1 | 2 | 3 | 4 | 5 |
|---|---|---|---|---|
| LC | K | LC | K | K |
| M | M | DC | DC | LC |
| Y | Y | Y | Y | M |

(Y: yellow, M: magenta, DC: dark cyan, LC: light cyan, K: black)

FIG. 3 illustrates an image forming apparatus using 6 color developers, in which each image unit includes developing units using two developers of different polarities.

The first image unit 110c may include a first developing unit 111c using a yellow developer and a second developing unit 112c using a dark cyan developer. The second image unit 120c may include a third developing unit 121c using a magenta developer and a fourth developing unit 122c using a dark cyan developer. The third image unit 130c may include a fifth developing unit 131c using a light cyan developer and a sixth developing unit 132c using the black developer.

In exemplary embodiments, the developers used in the first, third, and fifth developing units 111c, 121c, 131c may have polarities opposite to that of the developers used in the second, fourth, and sixth developing units 112c, 122c, 132c. In an exemplary embodiment, the dark cyan, light magenta, black developers used in the second, fourth, and sixth developing units 112c, 122c, 132c may have a positive polarity.

Although the above configuration may be advantageous in achieving compactness of an image forming apparatus, a problem may occur in reproducing a green color by overlapping yellow and dark cyan. However, this problem may be compensated for by adding black to a combination of yellow and light cyan.

As illustrated in FIGS. 4 to 6, a plurality of developing units using developer of different polarities are installed in a single image unit in various methods so that a color reproduction may be improved without increasing a number of image units. Color forming method is similar to the above-described method and thus detailed description is omitted.

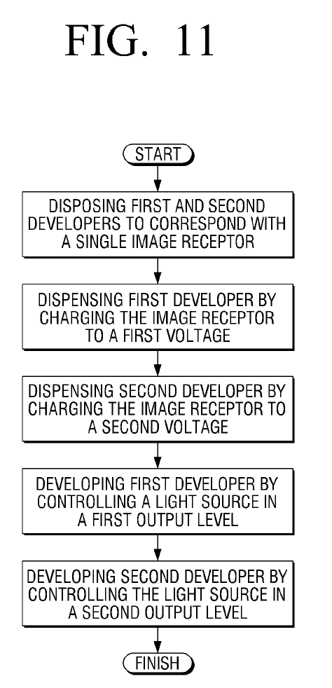

FIG. 11 is a flowchart illustrating an exemplary embodiment of a method of forming an image of an image forming apparatus according to the present general inventive concept.

Referring to FIG. 11, the method of forming an image includes an operation of disposing first and second developers to correspond with a single image receptor (operation 810). The first developer may be dispensed by charging the single image receptor to a first voltage (operation 820) and the second developer may be dispensed by charging the single image receptor to a second voltage (operation 830). The first developer may be developed by controlling a light source in a first output level (operation 840) and the second developer may be developed by controlling the light source in a second output level (operation 850). However, the present general inventive concept is not limited thereto. That is, in alternative exemplary embodiments, neither the first nor the second developer may be developed when the light source is controlled in a third output level (not illustrated).

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus comprising:
a developing device comprising:
at least one image unit using developers of opposite polarities and different colors simultaneously; and
at least one image unit using a single color developer of a constant polarity;
a light source device comprising:
a plurality of light sources to form an electrostatic latent image on the plurality of image units; and
a controller to control output of the light source in at least three output levels.

2. The image forming apparatus of claim 1, wherein a negative polarity developer is developed on a surface of an image receptor where an electrostatic latent image is formed by controlling the light source in a first output level of full-on, and a positive polarity developer is developed on a surface of an image receptor where an electrostatic latent image is formed by controlling the light source in a second output level of off, and a surface of an image receptor where an electrostatic latent image is formed by controlling the light source in a third output level of half-on is set to a non-image area on which a developer is not developed.

3. The image forming apparatus of claim 2, wherein the positive polarity developer has an electric charge from about +5 to about +50 μC/g, and the negative polarity developer has an electric charge from about −5 to about −50 μC/g.

4. The image forming apparatus of claim 1, wherein the developing device comprises first through third image units which use single-color developers of a same polarity, and a fourth image unit which uses developers of different polarities.

5. The image forming apparatus of claim 4, wherein the first image unit uses a yellow developer, the second image unit uses a magenta developer, and the third image unit uses a dark cyan developer, and the fourth image unit comprises a first developing unit using a light cyan developer having the same polarity as the developers used in the first through the third image units, and a second developing unit using a black developer having a polarity opposite to that of the developers of the first through the third image units.

6. The image forming apparatus of claim 1, wherein the developing device comprises a first image unit using a single color developer, and second and third image units which have a plurality of developing units using developers of different colors and different polarities.

7. The image forming apparatus of claim 6, wherein the first image unit uses a yellow developer, the second image unit comprises a first developing unit using a magenta developer and a second developing unit using a dark cyan developer, and the third image unit comprises a third developing unit using a light cyan developer and a fourth developing unit using a black developer.

8. The image forming apparatus of claim 7, wherein the developers used in the first and the third developing units have a polarity opposite to that of the developers used in the second and the fourth developing units.

9. The image forming apparatus of claim 1, wherein the developing device comprises first through third image units each having a plurality of developing units using developers of different colors and different polarities.

10. The image forming apparatus of claim 9, wherein the first image unit comprises a first developing unit using a yellow developer and a second developing unit using a dark cyan developer, the second image unit comprises a third developing unit using a magenta developer and a fourth developing unit using a dark cyan developer, and the third image unit comprises a fifth developing unit using a light cyan developer and a sixth developing unit using a black developer.

11. The image forming apparatus of claim 10, wherein the developers used in the first, third, and fifth developing units have a polarity opposite to that of the developers used in the second, fourth, and sixth developing units.

12. The image forming apparatus of claim 1, wherein the developing device comprises first and fourth image unit using developers of different polarities, and second and third image units using single-color developers of the same polarity.

13. The image forming apparatus of claim 12, wherein the first image unit comprises a first developing unit using a yellow developer and a second developing unit using a light magenta developer, the second unit uses a dark magenta developer, the third image unit uses a dark cyan developer, and the fourth image unit comprises a third developing unit using a light cyan developer and a fourth developing unit using a black developer.

14. The image forming apparatus of claim 1, wherein the developing device comprises first, third and fourth image units each using developers of different polarities, and a second image unit using a single color developer of a single polarity.

15. The image forming apparatus of claim 14, wherein the first image unit comprises a first developing unit using a yellow developer and a second developing unit using a light magenta developer, the second image unit uses a dark magenta developer, the third image unit comprises a third developing unit using a dark cyan developer and a fourth developing unit using a gray developer, and the fourth image unit comprises a fifth developing unit using a light cyan and a sixth developing unit using a black developer.

16. The image forming apparatus of claim 1, wherein the developing device comprises first through fourth image units each using developers of opposite polarities.

17. The image forming apparatus of claim 16, wherein the first image unit comprises a first developing unit using a yellow developer and a second developing unit using a light magenta developer, the second image unit comprises a third developing unit using a dark magenta developer and a fourth developing unit using a gold developer, the third image unit comprises a fifth developing unit using a dark cyan developer and a sixth developing unit using a silver developer, and the fourth image unit comprises a seventh developer using a light cyan developer and an eighth developing unit using a black developer.

18. The image forming apparatus of claim 1, wherein the developing device further comprises a developer charging device to make the polarity of the developer developed on the image receptor uniform.

19. The image forming apparatus of claim 18, wherein the developer charging device includes a corona charging device.

20. An image forming apparatus comprising:
a developing device which comprises at least one image unit using developers of opposite polarities and different colors;
a light source device which comprises a plurality of light sources to form an electrostatic latent image in the at least one image unit; and
a controller to control output of the light sources in a three output level way,
wherein a negative polarity developer is developed on a surface of an image receptor where an electrostatic latent image is formed by controlling the light source in a first output level of full-on, a positive polarity developer is developed on a surface of an image receptor where an electrostatic latent image is formed by controlling the light source in a second output level of off, and a surface of an image receptor where an electrostatic latent image is formed by controlling the light source in a third output level of half-on is set to a non-image area on which a developer is not developed.

21. An image unit usable in an image forming apparatus, comprising:
an image receptacle to be charged with three different levels to be formed with an electrostatic latent image; and
two developing units disposed around the image receptacle to develop the electrostatic latent image with three different levels with two different developers.

22. The image unit of claim 21, further comprising:
a light source to output light with three different levels to the image receptacle to form the electrostatic latent image.

23. The image unit of claim 21, further comprising:
a developer collecting unit to collect two developers from the image receptacle.

24. An image forming apparatus comprising:
an image unit comprising:
an image receptacle to be charged with three different levels to be formed with an electrostatic latent image; and
two developing units disposed around the image receptacle to develop the latent image with three different levels with two different developers; a light source comprising:
a plurality of light sources to form the latent image on the image unit; and a controller to control output of the light source in at least three output levels.
